(19) United States
(12) Patent Application Publication
(10) Pub. No.: US 2026/0246653 A1
(43) Pub. Date: Aug. 20, 2026

(54) METHOD, APPARATUS AND NON-TRANSITORY COMPUTER READABLE MEDIUM FOR GENERATING UNCLONABLE AND NON-FUNGIBLE DATA FOR DIGITAL RESOURCES

(71) Applicant: ASIA VISION INVESTMENT LIMITED, Hong Kong (CN)

(72) Inventors: Michael Chao KUAN, Hong Kong (CN); Justin T. Y. KUAN, Hong Kong (CN)

(21) Appl. No.: 19/489,596

(22) PCT Filed: Jun. 6, 2024
(86) PCT No.: PCT/CN2024/097724

§ 371 Date: Dec. 3, 2025

(30) Foreign Application Priority Data
Jun. 6, 2023 (WO) PCT/CN2023/098552

(51) Int. Cl. H04L 9/32; G06F 21/57; G06F 21/73; H04L 9/08; H04L 9/30

(52) U.S. Cl. CPC H04L 9/3278; G06F 21/572; G06F 21/73; H04L 9/0825; H04L 9/0866; H04L 9/30; H04L 9/3236

(57) ABSTRACT

Methods, apparatuses, and non-transitory computer-readable media are provided for generating unclonable and non-fungible data for digital resources. In one implementation, a method is provided that is implemented with at least one processor. The method includes acquiring at least a hardware feature of a hardware device and a biometric data of a user, generating a unique digital code for generated data; generating unclonable and non-fungible identification information based on the unique digital code, the hardware feature, and the biometric data, and associating the unclonable and non-fungible identification information with the generated data to obtain unclonable and non-fungible data.

### TECHNICAL FIELD

The present disclosure relates to a method, an apparatus, and a non-transitory computer readable medium for generating unclonable and non-fungible data for digital resources.

### BACKGROUND

In today's rapidly expanding digital landscape, managing, authenticating and protecting digital resources has become paramount. Digital resources include content products, digital files, electronic documents and data streams, such as digital media, computer software, etc., which are generated by hardware using digital technology and can be distributed, transmitted, and even traded in a form of data. Existing solutions for digital authentication, including to guarantee the integrity and authenticity of the digital resources, rely on approaches such as digital watermarks and digital signatures or certificates. While these approaches offer some security, they have limitations and drawbacks, such as being vulnerable to malicious attacks and hacking. Furthermore, they are insufficient to address the growing need to manage and authenticate an increasing number of digital resources created by hardware and other sources.

In this context, there is a need for more robust computer-implemented systems and methods to guarantee the integrity and authenticity of digital resources. The present disclosure describes improved solutions that alleviate or overcome one or more drawbacks of known approaches. The disclosed embodiments include innovative systems, methods, and non-transitory computer readable media for generating unclonable and non-fungible data for digital resources.

### SUMMARY OF THE DISCLOSURE

Embodiments of the present disclosure provide computer-implemented methods for generating unclonable and non-fungible data. In some embodiments, a method is provided that is implemented with at least one processor. The method includes: acquiring at least a hardware feature of a hardware device and a biometric data of a user; generating a unique digital code for generated data; generating unclonable and non-fungible identification information based on the unique digital code, the hardware feature, and the biometric data; and associating the unclonable and non-fungible identification information with the generated data to obtain unclonable and non-fungible data.

Embodiments of the present disclosure provide computer-implemented systems for generating unclonable and non-fungible data. In some embodiments, a system is provided that includes an acquiring unit configured to acquire a hardware feature of a hardware device and a biometric data of a user; and a processing unit coupled to the acquiring unit and configured to: generate a unique digital code for generated data; generate unclonable and non-fungible identification information based on the unique digital code, the hardware feature, and the biometric data; and associate the unclonable and non-fungible identification information with the generated data to obtain unclonable and non-fungible data.

Embodiments of the present disclosure also include a non-transitory computer readable medium that stores a set of instructions executable by one or more processors to perform operations for generating unclonable and non-fungible data. The operations may provide a method that includes: acquiring a hardware feature of a hardware device and a biometric data of a user; generating a unique digital code for generated data; generating unclonable and non-fungible identification information based on the unique digital code, the hardware feature, and biometric data; and associating the unclonable and non-fungible identification information with the generated data to obtain unclonable and non-fungible data.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1A is a schematic diagram illustrating an exemplary method for generating unclonable and non-fungible data for an original resource, according to some embodiments of the present disclosure.

FIG. 1B is a schematic diagram illustrating an exemplary method for generating unclonable and non-fungible data for an external resource, according to some embodiments of the present disclosure.

FIG. 1C is a schematic diagram illustrating another exemplary method for generating unclonable and non-fungible identification information, according to some embodiments of the present disclosure.

FIG. 2A is a schematic diagram illustrating another exemplary method for generating unclonable and non-fungible data for an original resource, according to some embodiments of the present disclosure.

FIG. 2B is a schematic diagram illustrating another exemplary method for generating unclonable and non-fungible data for an external resource, according to some embodiments of the present disclosure.

FIG. 2C is a schematic diagram illustrating another exemplary method for generating unclonable and non-fungible identification information, according to some embodiments of the present disclosure.

FIG. 2D is a schematic diagram illustrating another exemplary method for generating unclonable and non-fungible data for an original resource, according to some embodiments of the present disclosure.

FIG. 2E is a schematic diagram illustrating another exemplary method for generating unclonable and non-fungible data for an external resource, according to some embodiments of the present disclosure FIG. 2F is a schematic diagram illustrating another exemplary method for generating unclonable and non-fungible identification information, according to some embodiments of the present disclosure.

FIG. 3 is a schematic diagram illustrating an exemplary rights management scheme, according to some embodiments of the present disclosure.

FIG. 4A is a flow chart illustrating an exemplary method for generating unclonable and non-fungible data for a resource, according to some embodiments of the present disclosure.

FIG. 4B is a flow chart illustrating another exemplary method for generating unclonable and non-fungible data for a resource, according to some embodiments of the present disclosure.

FIG. 4C is a flow chart illustrating a still further exemplary method for generating unclonable and non-fungible identification information, according to some embodiments of the present disclosure.

FIG. 5A is a flow chart illustrating an exemplary method for generating unclonable and non-fungible data, according to some embodiments of the present disclosure.

FIG. 5B is a flow chart illustrating another exemplary method for generating unclonable and non-fungible data for a resource, according to some embodiments of the present disclosure.

FIG. 5C is a flow chart illustrating still another exemplary method for generating unclonable and non-fungible identification information, according to some embodiments of the present disclosure.

FIG. 6 is a flow chart illustrating sub-steps of an exemplary method for generating unclonable and non-fungible data, according to some embodiments of the present disclosure.

FIG. 7 is a flow chart illustrating sub-steps of another exemplary method for generating unclonable and non-fungible data, according to some embodiments of the present disclosure.

FIG. 8A is a schematic diagram illustrating exemplary apparatus for generating unclonable and non-fungible data, according to some embodiments of the present disclosure.

FIG. 8B is a schematic diagram illustrating another exemplary apparatus for generating unclonable and non-fungible data, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

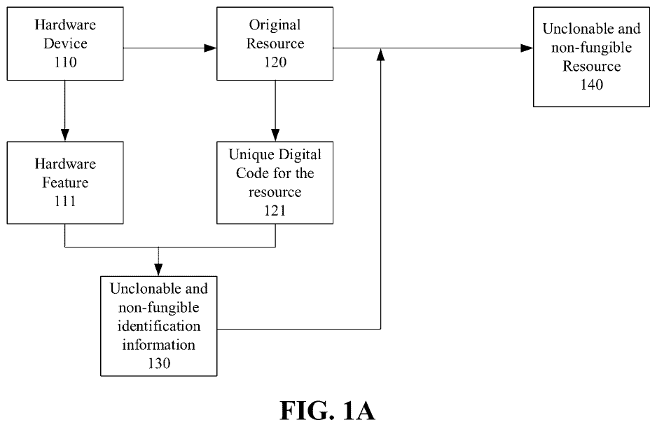

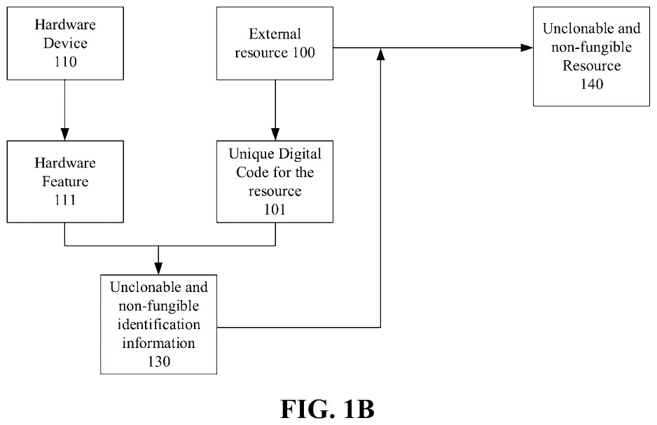

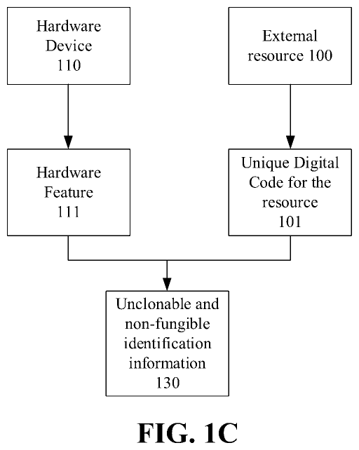

FIG. 1A is a schematic diagram illustrating an exemplary method for generating unclonable and non-fungible data for an original resource, according to some embodiments of the present disclosure. As shown in FIG. 1A, an original resource 120 is generated by a hardware device 110. It should be noted that a resource, such as original resource 120, can refer to an original digital resource or data. A digital resource or data can be in any form, such as, for example, a digital file, an electronic document, a data stream, or the like. In some embodiments, hardware device 110 is a digital camera used to generate digital pictures or digital videos. In some embodiments, hardware device 110 includes a module or functionality capable of generating or processing data streams, such as a sensor, camera, microphone, or any other device capable of capturing or generating specific types of data. Original resource 120 can be a data stream or data block, such as a heart rate or electrocardiogram (ECG) data stream from a heart rate or ECG sensor, an audio data stream from a microphone, or a video data stream from a camera. In some embodiments, hardware device 110 can be a computer, smart glasses, a drone, a car, or any other device equipped with the aforementioned module or functionality. Original resource 120 can also be a file, such as a piece of program code, an image or video file, a text document, or any other file(s) generated by the hardware device or by software installed on the hardware device.

Still referring to FIG. 1A, a hardware feature 111 is acquired from hardware device 110. In some embodiments, hardware device 110 may comprise a smart phone, a computer, a digital camera, or any hardware having a sensor, a microphone, an image sensor (e.g., CCD or CMOS sensor), or the like. In some embodiments, hardware feature 111 is a physically unclonable function (PUF) of hardware device 110. A physical unclonable function (PUF) is a feature or property that exploits inherent randomness introduced during manufacturing to give a physical entity a unique ‘fingerprint’ or trust anchor. Therefore, the PUF can be used in a variety of applications such as anti-counterfeiting, identification, and authentication. In some embodiments, hardware device 110 includes one or more integrated circuits (ICs) and/or system-on-a-Chip (SoCs). Due to deep submicron manufacturing process variations, every transistor in an IC or SoC has slightly different physical properties. These variations lead to small but measurable differences in terms of electronic properties, such as transistor threshold voltages and gain factors. Since these process variations are not fully controllable during manufacturing, these physical device properties cannot be copied or cloned, and can be regarded as PUFs. In some embodiments, hardware device 110 includes a memory, and the PUF of the memory can be acquired as hardware feature 111. With hardware feature 111, hardware device 110 can be identified. In some embodiments, hardware feature 111 is acquired by a built-in or plug-in apparatus, which can function with the hardware device 110. In other embodiments, the PUF is measured or provided at the time of manufacturing hardware device 110 and stored in a memory or otherwise associated and retrievable with the device as hardware feature 111.

A unique digital code 121 is generated from original resource 120. For example, unique digital code 121 can be a hash value generated from original resource 120. A hash value is a string of hexadecimal values, generally 32 to 64 characters long. The hash value can be generated by various algorithms, for example, SHA-1, SHA-256, or the like, which is not limited herein. Unique digital code 121 of original resource 120 can not only guarantee the integrity of original resource 120, but also verify the origin. In some embodiments, unique digital code 121 can be generated based on features extracted from original resource 120. For example, the features of original resource 120 may include metadata features. Metadata features associated with original resource 120 may include structured information or data elements that describe various aspects of original resource 120, such as its title, author, date of creation, subject, format, and other relevant characteristics. For example, for a digital picture or a digital video, metadata features may include the time, position, luminance of a picture, file features (e.g., size, type, etc.), and the like. In some embodiments, unique digital code 121 may be customizable. For example, unique digital code 121 may be a hash value with some customizable parameters (e.g., length, security level etc.). In another example, unique digital code 121 may be a subset of metadata features selected from a larger set of metadata features.

Unclonable and non-fungible identification information 130 includes data that is generated based on hardware feature 111 and unique digital code 121. Since hardware device 110 can be identified by hardware feature 111 and the integrity of original resource 120 can be guaranteed by unique digital code 121, both where original resource 120 is generated from and the integrity of original resource 120 can be identified and guaranteed with unclonable and non-fungible identification information 130. In some embodiments, unclonable and non-fungible identification information 130 is a character string or a binary code. In some embodiments, unclonable and non-fungible identification information 130 is a digital watermark, digital signature or digital certificate.

Still referring to FIG. 1A, unclonable and non-fungible identification information 130 is associated with original resource 120. Accordingly, an unclonable and non-fungible resource 140 is obtained. In this context, the term “associating” or “associated with” refers to establishing a verifiable link or connection between the unclonable and non-fungible identification information 130 and the original resource 120. This association or link allows the unclonable and non-fungible identification information 130 to be referenced, retrieved, or validated. In some embodiments, “associating” unclonable and nonfungible identification 130 with original resource 120 may include embedding unclonable and nonfungible identification 130 into original resource 120. In some other embodiments, “associating” unclonable and nonfungible identification 130 with original resource 120 may include referencing, mapping, linking, tagging, or cross-referencing unclonable and nonfungible identification 130 within original resource 120. Since unclonable and non-fungible resource 140 is associated with (e.g., linked or embedded into) unclonable and non-fungible identification information 130, both integrity and authenticity of the original resource are improved, and unclonable and non-fungible resource 140 can also be verifiable and/or traceable based on unclonable and non-fungible identification information 130. In some embodiments, unclonable and non-fungible identification information 130 embedded in unclonable and non-fungible resource 140 can be read or identified by a specific device, and is invisible to the public. Example embodiments for providing verification and authentication processes are further described below.

In some embodiments, the unclonable and non-fungible identification information can be embedded using invisible or visible watermarking. In some embodiments, the unclonable and non-fungible identification 130 information is embedded into the unclonable and non-fungible resource 140 by a security chip, etc. For example, in an example embodiment, hardware device 110 may include a security chip or a security module configured to take as an input hardware feature 111 and original resource 120, generate a unique digital code for the resource 121, generate unclonable and non-fungible identification information 130, and output unclonable and non-fungible resource 140, wherein the unclonable and non-fungible identification 130 information is embedded into resource 140. It is to be appreciated that such a security chip or module may also output unique digital code for the resource 121 (e.g., as a hash value or generated based on features extracted from original resource 120), and/or unclonable and non-fungible identification information 130.

FIG. 1B is a schematic diagram illustrating an exemplary method for generating unclonable and non-fungible data for an external resource, according to some embodiments of the present disclosure. Such a method is similar to the one presented in FIG. 1A in the context of an original resource but applies to an external resource. As shown in FIG. 1B, an external resource 100 is provided or received. It should be noted that an external resource 100 can include to an external digital resource or data. An external resource is different from an original resource and may be a resource that is external to, e.g., the system pr process that generates the unclonable and non-fungible data. A digital resource or data can be in any form, such as, for example, a digital file, an electronic document, a data stream, or the like. External resource 100 may be provided or received from an external hardware device that includes a module or functionality capable of generating or processing data streams, such as a sensor, camera, microphone, or any other device capable of capturing or generating specific types of data. External resource 100 can be a data stream or data block, such as a heart or ECG data stream from a heart or ECG sensor, an audio data stream from a microphone, or a video data stream from a camera. External resource 100 can also be a file, such as a piece of program code, an image or video file, a text document, or any other file(s) generated by the external hardware device or by software installed on the external hardware device.

A unique digital code 101 is generated from external resource 100. For example, unique digital code 101 can be a hash value generated from external resource 100. A hash value is a string of hexadecimal values, generally 32 to 64 characters long. The hash value can be generated by various algorithms, for example, SHA-1, SHA-256, or the like, which is not limited herein. Unique digital code 101 of external resource 100 can not only guarantee the integrity of external resource 100, but also verify the origin. In some embodiments, unique digital code 101 can be generated based on features extracted from external resource 100. For example, the features of external resource 100 may include metadata features. Metadata features associated with external resource 100 may include structured information or data elements that describe various aspects of external resource 100, such as its title, author, date of creation, subject, format, and other relevant characteristics. For example, for a digital picture or a digital video, metadata features may include the time, position, luminance of a picture, file features (e.g., size, type, etc.), and the like. In some embodiments, unique digital code 101 may be customizable. For example, unique digital code 101 may be a hash value with some customizable parameters (e.g., length, security level etc.). In another example, unique digital code 101 may be a subset metadata features selected from a larger set of metadata features.

Still referring to FIG. 1B, a hardware feature 111 is acquired from hardware device 110. Details about hardware feature 111 shown in FIG. 1B are those described above with reference to FIG. 1A which will not be repeated herein. In particular, hardware feature 111 may correspond to a physically unclonable function (PUF) of hardware device 110.

Unclonable and non-fungible identification information 130 is generated based on hardware feature 111 and unique digital code 101. Since hardware device 110 can be identified by hardware feature 111 and the integrity of external resource 100 can be guaranteed by unique digital code 101, the integrity of external resource 100 can be identified and guaranteed with unclonable and non-fungible identification information 130. In some embodiments, unclonable and non-fungible identification information 130 is a character string or a binary code. In some embodiments, unclonable and non-fungible identification information 130 is a digital watermark, digital signature or digital certificate.

Still referring to FIG. 1B, unclonable and non-fungible identification information 130 is associated with external resource 100. Accordingly, an unclonable and non-fungible resource 140 is obtained. In this context, the term “associating” or “associated with” refers to establishing a verifiable link or connection between the unclonable and non-fungible identification information 130 and the external resource 100. This association or link allows the unclonable and non-fungible identification information 130 be referenced, retrieved. In some embodiments, associating unclonable and nonfungible identification 130 with external resource 100 may include embedding unclonable and nonfungible identification 130 into external resource 100. In some other embodiments, associating unclonable and nonfungible identification 130 with external resource 100 may include referencing, mapping, linking, tagging, or cross-referencing unclonable and nonfungible identification 130 within original resource 120. Since unclonable and non-fungible resource 140 is associated with (e.g., linked or embedded into) unclonable and non-fungible identification information 130, both integrity and authenticity of the external resource are improved, and unclonable and non-fungible resource 140 can also be verifiable and/or traceable based on unclonable and non-fungible identification information 130. In some embodiments, unclonable and non-fungible identification information 130 embedded in unclonable and non-fungible resource 140 can be read or identified by a specific device, and is invisible to the public. In some embodiments, the unclonable and non-fungible identification information can be embedded using invisible or visible watermarking.

FIG. 1C is a schematic diagram illustrating an exemplary method for generating unclonable and non-fungible identification information, according to some embodiments of the present disclosure. The steps of the method illustrated in FIG. 1C are similar to those presented in FIG. 1B, except that the final association is not performed. The details pertaining to these aforementioned steps are not repeated herein. In such a situation, the unclonable and non-fungible identification information 130 is directly outputted and may be used for verification and authentication processes. While FIG. 1C illustrates the generation and direct output of unclonable and non-fungible information 130 associated with external resource 100, as shown in FIG. 1B. As will be appreciated from this disclosure, a similar process may be performed for original resource 120, as shown in FIG. 1A.

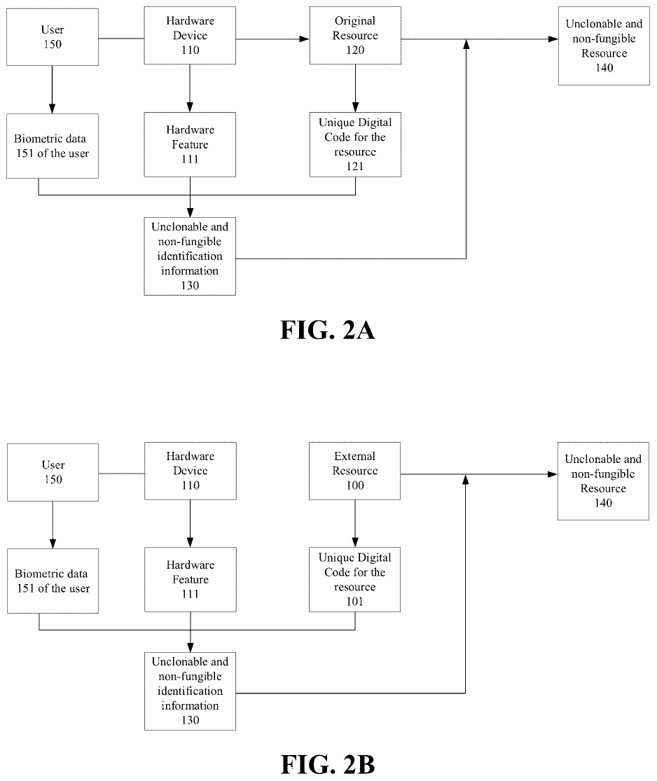

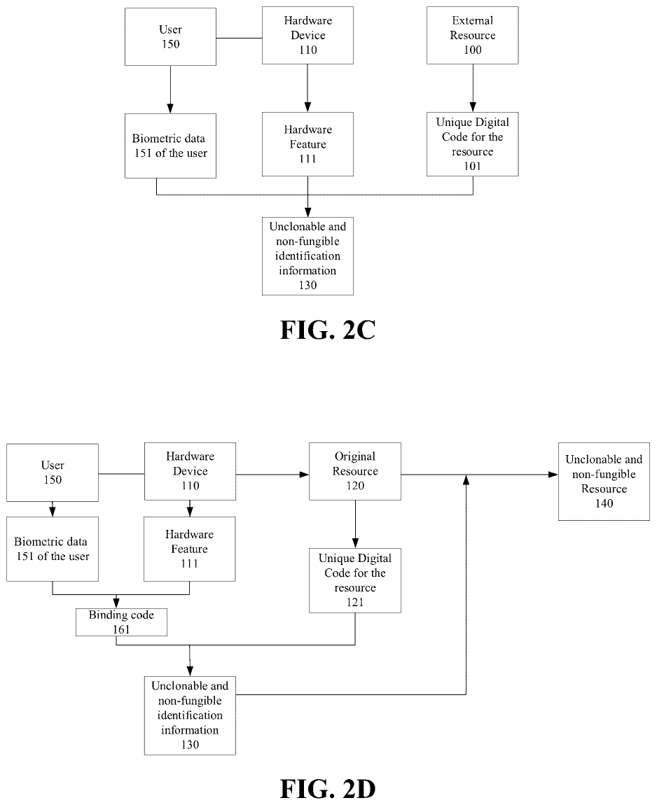

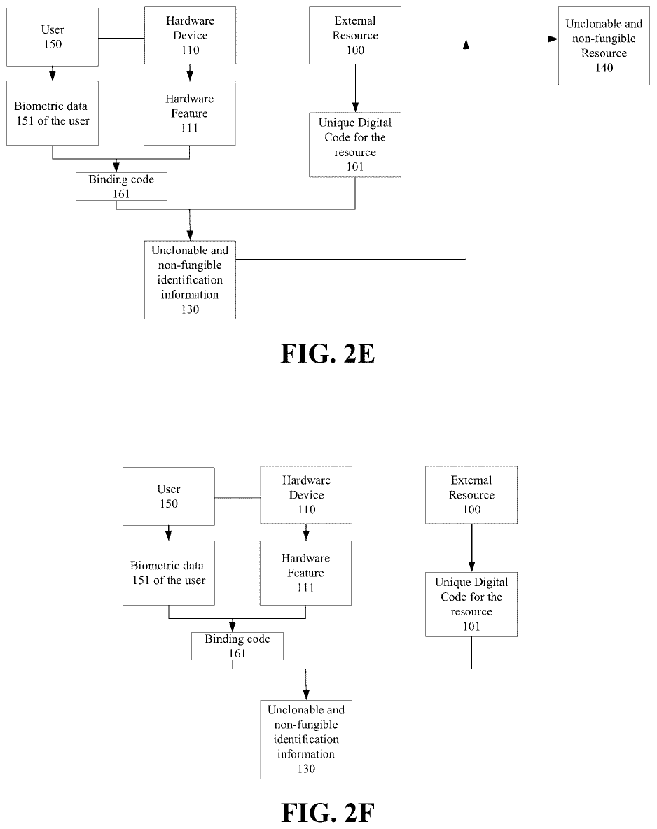

FIG. 2A is a schematic diagram illustrating another exemplary method for generating unclonable and non-fungible data for an original resource, according to some embodiments of the present disclosure. As shown in FIG. 2A, biometric data 151 can be acquired for a user 150. User 150 can generate original resource 120. In some embodiments, user 150 generates original resource 120 using a hardware device. For example, the hardware device includes a module or functionality capable of generating or processing data streams, such as a sensor, camera, microphone, or any other device capable of capturing or generating specific types of data. Original resource 120 can be a data stream or data block, such as a heart rate or ECG data stream from a heart rate or ECG sensor, an audio data stream from a microphone, or a video data stream from a camera. In some embodiments, the hardware device includes a computer, smart glasses, a drone, a car, or any other device equipped with the aforementioned module or functionality, and original resource 120 is a file, such as a piece of program code, an image or video file, a text document, or any other file generated by the hardware device or by software installed on the hardware device. Biometric data 151 includes one or more of a fingerprint, a facial feature, an iris, a voiceprint, a heartbeat, a pulse, body temperature, or the like. In some embodiments, the hardware device may include corresponding components for acquiring biometric data 151, for example, various sensors, a camera, a microphone, etc.

Still referring to FIG. 2A, hardware feature 111 is acquired. Hardware feature 111 may be a physically unclonable function (PUF) of hardware device 110. In some embodiments, at least one of biometric data 151 and hardware feature 111 are acquired by a built-in or plug-in apparatus, which can function with the hardware device. In some embodiments, user 150 can have different roles, for example, user 150 may be an owner of hardware device 110, an operator of hardware device 110, an owner of original resource 120, or the like. It can be understood that user 150 may have one or more roles, for example, user 150 can be the owner of hardware device 110 and the owner of original resource 120, or user 150 can be the owner of hardware device 110 but not the owner of original resource 120, which depends on specific scenarios. By identifying the biometric data 151, the user can be identified, and corresponding information and/or rights can be further identified, which will be described later.

In the exemplary method shown in FIG. 2A, unclonable and non-fungible identification information 130 is generated based on biometric data 151, hardware feature 111, and unique digital code 121. Therefore, for unclonable and non-fungible identification information 130, not only information about the resource itself can be identified, but also information about a user can be identified, which can be further used to realize rights management of hardware device 120 and/or original resource 130. Details about unique digital code for the resource 121 are similar to those described above with reference to FIG. 1A, which will not be repeated herein.

FIG. 2B is a schematic diagram illustrating another exemplary method for generating unclonable and non-fungible data for an external resource, according to some embodiments of the present disclosure. Such a method is similar to the one presented in FIG. 2A in the context of an original resource, but applies to an external resource. User 150 can provide or generate external resource 100. In some embodiments, user 150 provides or generates external resource 100 using an external hardware device. For example, the external hardware device can include a module or functionality capable of generating or processing data streams, such as a sensor, camera, microphone, or any other device capable of capturing or generating specific types of data. External resource 100 can be a data stream or data block, such as a heart rate data stream from a heart rate sensor, an audio data stream from a microphone, or a video data stream from a camera. In some embodiments, external resource 100 may not be generated by user 150. However, user 150 may want to establish a connection with external resource 100. For example, user 150 may intend to digitally sign the external resource 100. User 150 operates hardware device 100, which takes the external resource 100 as the input, and outputs the unclonable and non-fungible resource 140, which is associated with (e.g., embedded into) unique digital code 121.

As shown in FIG. 2B both biometric data 151 and hardware feature 111 are provided or acquired. Details about hardware feature 111 and biometric data shown in FIG. 2B are similar to those described above with reference to FIG. 2A, which will not be repeated herein. Similarly, details about unique digital code for the resource 101 are similar to those described above with reference to FIG. 1B.

FIG. 2C is a schematic diagram illustrating another exemplary method for generating unclonable and non-fungible identification information, according to some embodiments of the present disclosure. The steps of the method illustrated in FIG. 2C are similar to those presented in FIG. 2B, except that the final association is not performed. The details pertaining to these aforementioned steps are not repeated herein. In this context, the unclonable and non-fungible identification information 130 is directly outputted and may be used for verification and authentication processes. While FIG. 2C illustrates the generation and direct output of unclonable and non-fungible information 130 associated with external resource 100, as shown in FIG. 2B, a similar process may be performed for original resource 120, as shown in FIG. 2A.

FIG. 2D is a schematic diagram illustrating another exemplary method for generating unclonable and non-fungible data for an original resource, according to some embodiments of the present disclosure. In some embodiments, biometric data 151 and hardware feature 111 can be bound first, which generates a binding code 161. Then, unclonable and non-fungible identification information 130 is generated based on unique digital code 121 and the binding code 161. In some embodiments, the binding code 161 may be computed locally within the hardware 110. This binding computation takes two inputs: the biometric data 151 and the hardware feature 111. The computation can vary from simple mathematical functions like addition and multiplication to more complex functions like hashing algorithms. One objective of this binding operation is to generate a unique code that is difficult to guess. Since both biometric data 151 and hardware feature 111 can only be accessed locally within the hardware 110, they are secure and difficult to guess. This additional layer of computation and resultant binding of the data makes breaking the binding code 161 extremely costly, while the cost of computing 161 remains very low. Moreover, a benefit of this binding step is that even if the code is compromised, only one pair of hardware feature and biometric data is affected, making the return on investment (ROI) for such an attack very low and unattractive. Creating this asymmetry of costs represents another objective and benefit of this implementation.

In some embodiments, the binding code 161 may serve as a root key for further processes. For instance, it can be used to generate public-private key pairs. The private key is then used to encrypt the unique digital code 121 and generate a unclonable and non-fungible identification information 130. The public key can be registered on a central server or published to a decentralized network, such as blockchains. This public key can be used to verify the digital certificate. Unlike conventional PKI solutions, the root key and private key in this approach are never stored. They are computed every time they are needed. This method not only reduces the risk of key theft but also minimizes the complexity of key management since there are no keys to manage.

Details about hardware feature 111, biometric data 151, and unique digital code 121 shown in FIG. 2D are similar to those described above with reference to FIGS. 2A-2C, which will not be repeated herein. In particular, a hardware device (e.g., hardware device 110) may include a security chip or a security module configured to take as an input hardware feature 111, biometric data 151, and original resource 120, generate unique digital code for the resource 121, generate unclonable and non-fungible identification information 130, and output unclonable and non-fungible resource 140, wherein the unclonable and non-fungible identification 130 information is associated with the resource 140. It is to be appreciated that such a security chip or module may also output unique digital code for the resource 121 (e.g., as a hash value or as generated based on features extracted from original resource 120), and/or unclonable and non-fungible identification information 130.

FIG. 2E is a schematic diagram illustrating another exemplary method for generating unclonable and non-fungible data for an external resource, according to some embodiments of the present disclosure. Such a method is similar to the one presented in FIG. 2D in the context of an original resource, but applies to an external resource 100.

FIG. 2F is a schematic diagram illustrating another exemplary method for generating unclonable and non-fungible identification information, according to some embodiments of the present disclosure. The steps of the methods illustrated in FIG. 2F are similar to those presented in FIG. 2E, except that the final association is not performed. The details pertaining to these aforementioned steps are not repeated herein. In this context, the unclonable and non-fungible identification information 130 is directly outputted and may be used for verification and authentication processes. While FIG. 2F illustrates the generation and direct output of unclonable and non-fungible information 130 associated with external resource 100, as shown in FIG. 2E, a similar process may be performed for original resource 120, as shown in FIG. 2D.

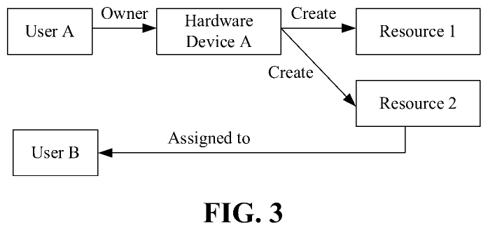

In some embodiments, rights information for the user is created according to the user and associated with unclonable and non-fungible identification information 130. For example, there may be several roles for a user: owner of the hardware device, creator of the original resource, and/or owner of the original resource. Each role corresponds to a group of rights. FIG. 3 is a schematic diagram illustrating an exemplary rights management scheme, according to some embodiments of the present disclosure. Referring to FIG. 3, user A is the owner of hardware device A and creates resource 1 and resource 2. User A may have roles of the owner of hardware device A, the creator of resource 1 and resource 2, and the owner of resource 1 and resource 2. Therefore, user A may have the rights to access and operate hardware device A to generate new resources (for example, take photos, make videos, create a text fill, etc.), and also have the rights of disposition of the resource 1 and resource 2, that is, user A can edit or delete the resource 1 and resource 2. In some embodiments, user A can assign the resource 1 and resource 2 to another user, that is, the role of owner of the resource can be assigned to another user, and user A may only have the role of creator of the resources. For example, resource 2 may be assigned to user B. Then, user B is the owner of resource 2 and has the rights of disposition of the resource 2, and user A cannot edit or delete resource 2, but can be identified as the creator of resource 2. The rights information for a user is created according to the user and associated with the unclonable and non-fungible identification information. Then, the unclonable and non-fungible identification information is stored, and the rights information associated with the unclonable and non-fungible identification information can be obtained according to a preset rule. In some embodiments, the unclonable and non-fungible identification information is stored in the hardware device. In some embodiments, the unclonable and non-fungible identification information is stored in an external memory. For example, the external memory may include a smart card, a secure element (e.g., a hardware wallet), a hardware security module (e.g., YubiHSM2), an external secure storage device (e.g., an encrypted USB drive), and the like. In some embodiments, a one-time session key may be used together with the external memory.

In some embodiments, a role may be assigned to a user when the user needs to generate corresponding unclonable and non-fungible identification information. For example, a role list can be provided for the user to select from, before acquiring the biometric data from the user. After the biometric data of a user has been acquired using the hardware device, the biometric data acquired can be compared with the biometric data associated with the stored unclonable and non-fungible identification information, and corresponding rights information can be determined based on the comparison result. For example, if the biometric data of the user using the hardware device matches with the biometric data of the owner of the hardware device, then the user can operate the hardware device to generate new resources. If the biometric data of the user using the hardware device matches with the biometric data of the owner of a resource but does not match with the biometric data of the owner of the hardware device, then the user can dispose of the resource, for example, edit the resource, assign the resource to another user, etc., but the user cannot use the hardware device to generate new resources. In some embodiments, a role as a guest can be provided to a user for whom there is no need to generate corresponding unclonable and non-fungible identification information. Depending on specific scenarios, in some cases, a user with a guest role may only have the rights to access and browse the resources using the hardware device. In some cases, a user with a guest role has no rights to access the hardware device nor browse the resources. The rights management can be stored in a table including corresponding roles and rights, or can be realized by another method, which is not limit herein.

It can be understood that one or more pieces of unclonable and non-fungible identification information can be embedded in one original resource.

In some embodiments, the rights information can be different for a user based on different biometric data acquired. For example, the biometric data of an index finger fingerprint corresponds to a first right, and the biometric data of a thumbprint corresponds to a second right. The rights management rule can be preset accordingly.

As described above, in some embodiments, the unclonable and non-fungible identification information embedded in the unclonable and non-fungible resource can be read or identified by a specific device, and is invisible to the public. In this example, the unclonable and non-fungible identification information is a digital identifier. The digital identifier includes one or more of: a digital watermarking, a digital signature, a digital certificate, or the like. The digital identifier is further embedded into the unclonable and non-fungible resource. Therefore, the relevant public may recognize the unclonable and non-fungible resource through the digital identifier such as a digital watermarking, a digital signature, a digital certificate, or the like.

Meanwhile, the unclonable and non-fungible identification information is well protected from reading by the public. Therefore, the unclonable and non-fungible identification information cannot be forged and can be identified by a specific device. Thus, the robustness to guarantee integrity and authenticity of the digital resources is improved.

In some embodiments, the digital identifier can be embedded using invisible watermarking. In some embodiments, the digital identifier is embedded into the unclonable and non-fungible resource by a security chip, etc.

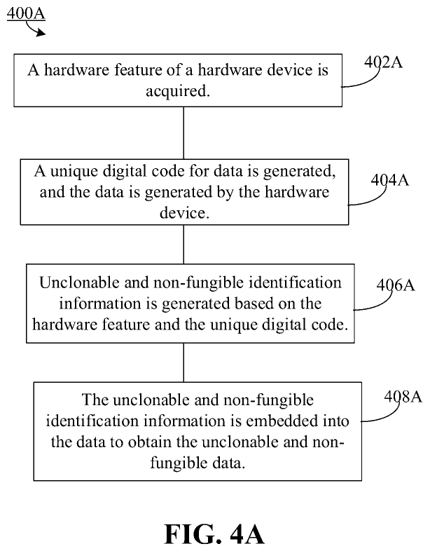

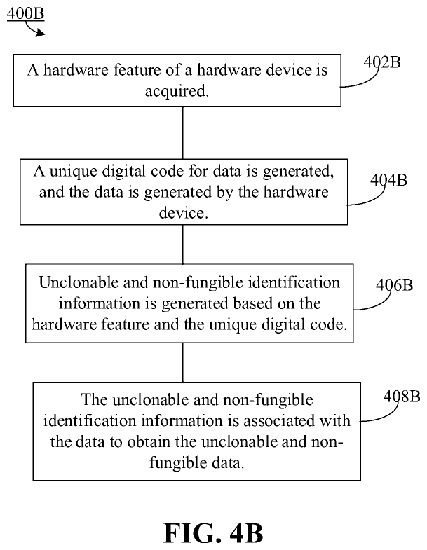

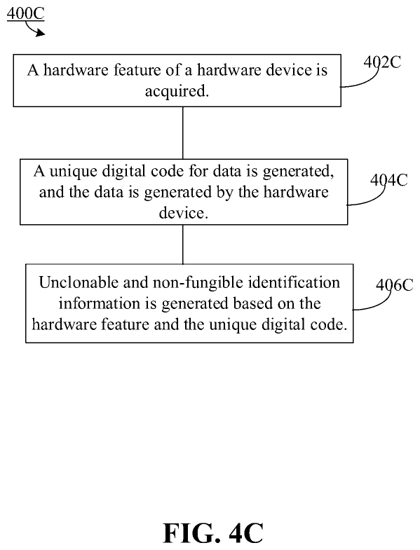

FIG. 4A is a flow chart illustrating an exemplary method 400A for generating unclonable and non-fungible data for a resource, e.g., original resource 120 in FIG. 1A, according to some embodiments of the present disclosure. Consistent with the above-described features and steps of FIG. 1A, method 400A includes steps 402A to 408A, as shown in FIG. 4A.

At step 402A, a hardware feature of a hardware device, e.g., hardware device 110 is provided or acquired. In some embodiments, the hardware device may comprise a smart phone, a computer, a camera, or any hardware having a sensor, a microphone, a camera, or the like. In some embodiments, the hardware feature is a PUF of the hardware device. In some embodiments, the hardware device includes an IC or SoC, and due to deep submicron manufacturing process variations, every transistor in an IC or SoC has slightly different physical properties. These variations lead to small but measurable differences in terms of electronic properties, such as transistor threshold voltages and gain factor. Since these process variations are not fully controllable during manufacturing, these physical device properties cannot be copied or cloned, and can be regarded as a PUF. In some embodiments, the hardware device includes a memory, and the PUF of the memory can be acquired as the hardware feature. With the hardware feature, the hardware device can be identified.

At step 404A, a unique digital code for data is generated. The data is generated by the hardware device. The data can also refer to a resource or a digital resource, e.g., original resource 120, and can be in a form of, for example, a digital file, an electronic document, a data stream, or the like. For example, the unique digital code, e.g., unique digital code 121, may be a hash value generated from the data. As explained above, a hash value is a string of hexadecimal values, generally 32 to 64 characters long. The hash value can be generated by various algorithms, for example, SHA-1, SHA-256, or the like, which is not limited herein. The unique digital code of the data can guarantee the integrity of the data. In some embodiments, the unique digital code is generated based on features extracted from the data. For example, the features of the data may include meta data feature (e.g., time, position) of a digital picture or a digital video, luminance of a picture, file features (e.g., size, type, etc.), and the like.

At step 406A, unclonable and non-fungible identification information is generated based on the hardware feature and the unique digital code. Since the hardware device can be identified by the hardware feature, and the integrity of the data can be guaranteed by the unique digital code, with the unclonable and non-fungible identification information, both where the data is generated from and the integrity of the data can be identified and guaranteed. In some embodiments, the unclonable and non-fungible identification information is a character string

At step 408A, the unclonable and non-fungible identification information is embedded into the data to obtain the unclonable and non-fungible data. Since the unclonable and non-fungible data has the embedded unclonable and non-fungible identification information, both integrity and authenticity of the original resource are improved. Unclonable and non-fungible data can also be verifiable and/or traceable based on unclonable and non-fungible identification information embedded. In some embodiments, the unclonable and non-fungible identification information embedded in the unclonable and non-fungible resource can be read or identified by a specific device, and is invisible to the public.

In some embodiments, the unclonable and non-fungible identification information can be embedded using invisible watermarking. In some embodiments, the unclonable and non-fungible identification information is embedded into the unclonable and non-fungible resource by a security chip, etc.

The unclonable and non-fungible data obtained by the above-described method 400A may be further used in various scenarios, including centralized or decentralized scenarios. In some embodiments, the unclonable and non-fungible data can be a digital collection, which can be distributed on a blockchain platform or exhibited in a digital museum. In some embodiments, the unclonable and non-fungible data can be a digital asset. For example, the digital asset may include digital music rights, software authorization information, car driving data, human heartbeat data, and the like.

FIG. 4B is a flow chart illustrating another exemplary method 400B for generating unclonable and non-fungible data for a resource, e.g., original resource 120 in FIG. 1A, according to some embodiments of the present disclosure. Consistent with the above-described features and steps of FIG. 1A, method 400B includes steps 402B to 408B, as shown in FIG. 4B. Steps 402B to 406B are similar to steps 402A to 406A shown in FIG. 4A, and thus the details of these steps will not be repeated herein. At step 408B, the unclonable and non-fungible identification information is associated with the data to obtain unclonable and non-fungible data. Since the unclonable and non-fungible data is directly associated with unclonable and non-fungible identification information, both the integrity and authenticity of the original resource are improved. Examples of direct association may include, for example: referencing, mapping, linking, tagging, cross-referencing, digital signature, cryptographic hashing, and/or embedding in metadata.

FIG. 4C is a flow chart illustrating a still further exemplary method 400C for generating unclonable and non-fungible identification information for a resource, e.g., original resource 120 in FIG. 1A, according to some embodiments of the present disclosure. Consistent with the above-described features and steps of FIG. 1A, method 400C includes steps 402C to 406C, as shown in FIG. 4C. Steps 402C to 406C are similar to steps 402A to 406A shown in FIG. 4A and steps 402B to 406B shown in FIG. 4B, and thus the details of these steps will not be repeated herein.

While processes 400A to 400C have been described in the context of data generated by the hardware device, i.e., original resource 120, it is to be appreciated that such processes may be replicated for data generated from an external hardware device, i.e., external resource 100, consistent with FIG. 1B and FIG. 1C.

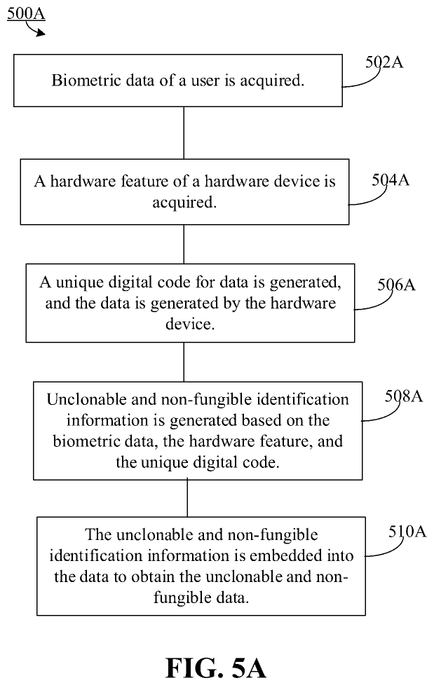

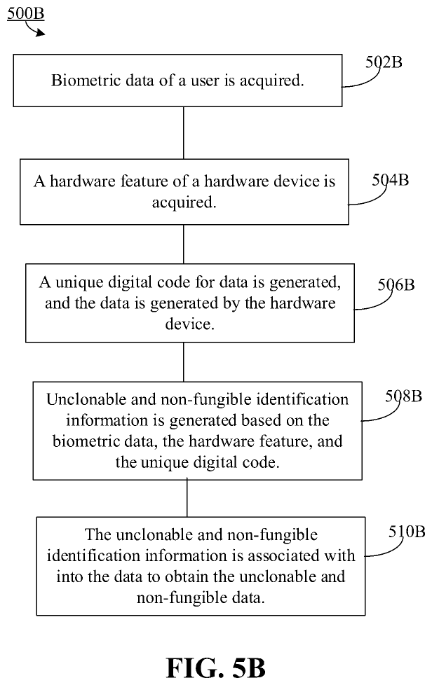

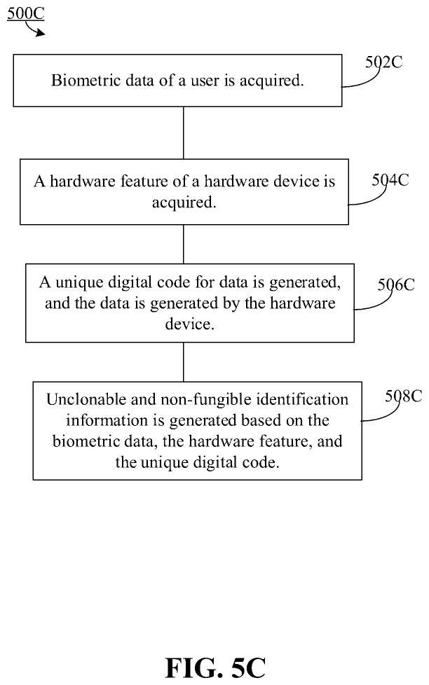

FIG. 5A is a flow chart illustrating an exemplary method 500A for generating unclonable and non-fungible data, according to some embodiments of the present disclosure. As shown in FIG. 5A, method 500A includes steps 502A to 512A.

At step 502A, biometric data of a user is acquired. The biometric data includes one or more of a fingerprint, a facial feature, an iris, a voiceprint, a heartbeat, a pulse, body temperature, or the like. In some embodiments, a hardware device may include corresponding components for acquiring the biometric data, for example, various sensors, a camera, a microphone, etc. In some embodiments, biometric data 151 is acquired by a built-in or plug-in apparatus, which can function with the hardware device. In some embodiments, the user can have different roles, for example, the user is an owner of the hardware device, an operator of the hardware device, an owner of data, or the like. It can be understood that the user may have one or more roles, for example, the user can be the owner of hardware device and the owner of data, or the user can be the owner of the hardware device but not the owner of the data, which depends on specific scenarios.

At step 504A, a hardware feature of a hardware device is acquired. In some embodiments, the hardware device may include a smart phone, a computer, a camera, or any hardware having a sensor, a microphone, a camera, or the like. In some embodiments, the hardware feature is a physically unclonable function (PUF) of the hardware device. In some embodiments, the hardware device includes an IC or SoC, and due to deep submicron manufacturing process variations, every transistor in an IC or SoC has slightly different physical properties. These variations lead to small but measurable differences in terms of electronic properties, such as transistor threshold voltages and gain factor. Since these process variations are not fully controllable during manufacturing, these physical device properties cannot be copied or cloned, and can be regarded as a PUF. In some embodiments, the hardware device includes a memory, and the PUF of the memory can be acquired as the hardware feature. With the hardware feature, the hardware device can be identified. In some embodiments, the hardware feature is acquired by a built-in or plug-in apparatus, which can function with the hardware device.

At step 506A, a unique digital code for data is generated. The data is generated by the hardware device. The data can also refer to a resource or a digital resource, and can be in a form of a digital file, an electronic document, a data stream, or the like. For example, the unique digital code is a hash value generated from the data, as described above. The unique digital code of the data can guarantee the integrity of the data. In some embodiments, the unique digital code is generated based on features extracted from the data. For example, the features of the data may include meta data features (e.g., time, position) of a digital picture or a digital video.

At step 508A, unclonable and non-fungible identification information is generated based on the biometric data, the hardware feature, and the unique digital code. In some embodiments, alternatively, step 508 includes a step of binding the biometric data and the hardware feature, and generating the unclonable and non-fungible identification information based on the unique digital code and the bound biometric data and hardware feature (see, e.g., FIG. 2B). In some embodiments, binding the biometric data and the hardware feature may include generating a cryptographic key with the biometric data and the hardware feature (see, e.g., FIG. 2B). For example, the cryptographic key can be generated by combining the biometric data and the hardware feature.

At step 510A, the unclonable and non-fungible identification information is embedded into the data to obtain the unclonable and non-fungible data. With the unclonable and non-fungible identification information, not only information about the data itself can be identified, but also the information about a user can be identified, which can be further used to realize rights management of the hardware device and/or the data.

In some embodiments, the unclonable and non-fungible identification information embedded in the unclonable and non-fungible resource can be read or identified by a specific device, and is invisible to the public.

FIG. 5B is a flow chart illustrating another exemplary method 500B for generating unclonable and non-fungible data for a resource, e.g., original resource 120 in FIG. 2A, according to some embodiments of the present disclosure. Consistent with the above-described features and steps of FIG. 2A, method 500B includes steps 502B to 510B, as shown in FIG. 5B. Steps 502B to 508B are similar to steps 502A to 508A shown in FIG. 5A, and thus the details of those steps will not be repeated herein. At step 510B, the unclonable and non-fungible identification information is associated with the data to obtain unclonable and non-fungible data. Since the unclonable and non-fungible data is directly associated with unclonable and non-fungible identification information, both the integrity and authenticity of the original resource are improved. Examples of direct association may include, for example: referencing, mapping, linking, tagging, cross-referencing, digital signature, cryptographic hashing, and/or embedding in metadata.

FIG. 5C is a flow chart illustrating still another exemplary method 500° C. for generating unclonable and non-fungible identification information for a resource, e.g., original resource 120 in FIG. 2A, according to some embodiments of the present disclosure. Consistent with the above-described features and steps of FIG. 2A, method 500C includes steps 502C to 508C, as shown in FIG. 5C. Steps 502C to 508C are similar to steps 502A to 508A shown in FIG. 5A and steps 502B to 508B shown in FIG. 5B, and thus the details of those steps will not be repeated herein.

While processes 500A to 500C have been described in the context of data generated by the hardware device, i.e., original resource 120, it is to be appreciated that such processes may be replicated for data generated from an external hardware device, i.e., external resource 100, consistent with FIG. 2B and FIG. 2C.

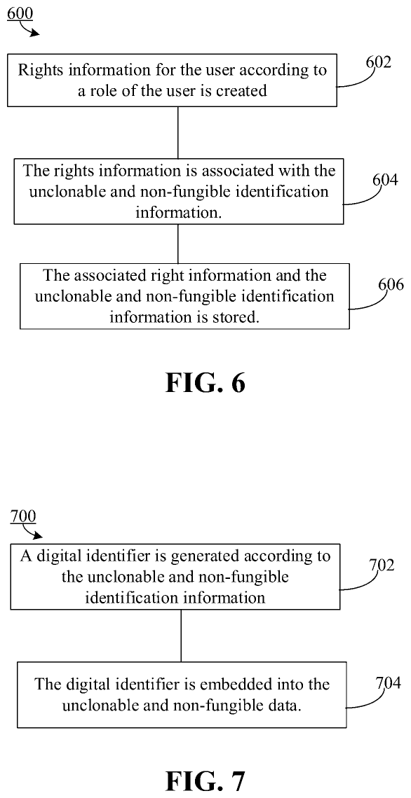

FIG. 6 is a flow chart illustrating sub-steps of an exemplary method 600 for generating unclonable and non-fungible data, according to some embodiments of the present disclosure. As shown in FIG. 6, method 600 further includes steps 602 to 606, following the steps of method 500A or 500B.

At step 602, rights information for the user according to a role the user is created. For example, there are several roles for a user, and rights information can be created for the user based on the roles and the biometric data. In some embodiments, a user may have different rights based on different biometric data provided according to a preset rule. For example, the biometric data of an index finger fingerprint corresponds to a first right, and the biometric data of a thumbprint corresponds to a second right. The rights management rule can be preset accordingly.

At step 604, the rights information is associated with the unclonable and non-fungible identification information. For example, one or more pieces of unclonable and non-fungible identification information can be embedded in one original resource, according to the steps of method 400B or 500 described above. Each piece of unclonable and non-fungible identification information may be associated with corresponding rights information.

At step 606, the associated right information and the unclonable and non-fungible identification information is stored in the hardware device or in an external device. Then, the rights information associated with the unclonable and non-fungible identification information can be obtained according to a preset rule. For example, after the biometric data of a user using the hardware device has been acquired, the biometric data acquired can be compared with the biometric data associated with stored unclonable and non-fungible identification information, and corresponding rights information can be determined based on the comparison result.

FIG. 7 is a flow chart illustrating sub-steps of another exemplary method 700 for generating unclonable and non-fungible data, according to some embodiments of the present disclosure. As shown in FIG. 7, following the steps of method 400A, 400B, 500A or 500B, method 700 further includes steps 702 and 704.

At step 702, a digital identifier is generated according to the unclonable and non-fungible identification information. The digital identifier includes one or more of: a digital watermarking, a digital signature, a digital certificate, or the like.

At step 704, the digital identifier is embedded into the unclonable and non-fungible data. In some embodiments, relevant public may recognize the unclonable and non-fungible resource through the digital identifier. Meanwhile, the unclonable and non-fungible identification information is well protected from reading by the public. Therefore, even if a digital watermark is forged, the unclonable and non-fungible identification information cannot be forged and can be identified by a specific device. Thus, the robustness to guarantee integrity and authenticity of the digital resources is improved.

In some embodiments, the digital identifier can be embedded using invisible watermarking. In some embodiments, the digital identifier is embedded into the unclonable and non-fungible resource by a security chip, etc.

Embodiments of the present disclosure further provide an apparatus for generating unclonable and non-fungible identification for data.

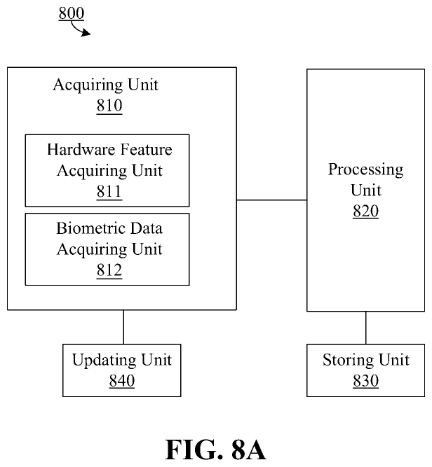

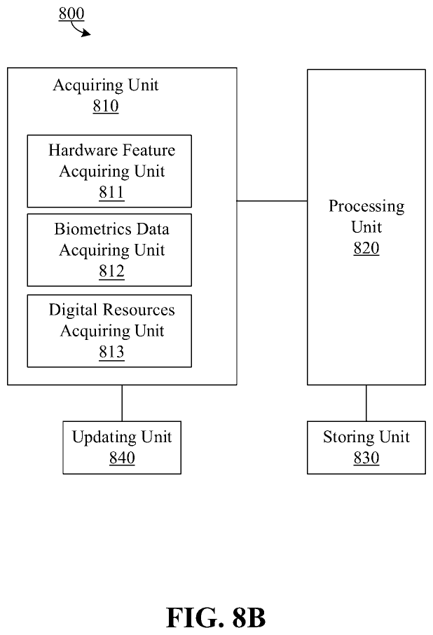

FIG. 8A is a schematic diagram illustrating an exemplary apparatus 800 for generating unclonable and non-fungible data, according to some embodiments of the present disclosure. Methods (e.g., methods 400A, 400B, 400C, 500A, 500B, 600 and 700) shown in FIGS. 4A to 7, can be carried out by apparatus 800. As shown in FIG. 8A, apparatus 800 includes an acquiring unit 810 including a hardware feature acquiring unit 811, which includes circuitry configured to collect a hardware feature of a hardware device. Acquiring unit 811 may be referred to as acquiring circuitry to acquire the hardware feature of the hardware device, for example, PUF information.

In some embodiments, acquiring unit 810 further includes a biometric data acquiring unit 812 including circuitry configured to collect biometric data of a user. Biometric data acquiring unit 812 may be referred to as biometric data acquiring circuitry. Biometric data acquiring unit 812 may include one or more of various sensors, a camera, a microphone, etc. The sensors may include a temperature sensor, an ECG (electrocardiogram) sensor, a pressure sensor, or the like.

Apparatus 800 further includes a processing unit 820 including one or more processors configured to generate a unique digital code for data generated by the hardware device, and generate unclonable and non-fungible identification information based on the unique digital code and at least one of the hardware feature or the biometric data. Processing unit 820 is further configured to embed the unclonable and non-fungible identification information into the data to obtain the unclonable and non-fungible data. Processing unit 820 may correspond to a security chip or a security module.

In some embodiments, processing unit 820 is further configured to generate the unclonable and non-fungible identification information based on the biometric data, the hardware feature, and the unique digital code. In some embodiments, Processing unit 820 is further configured to bind the biometric data and the hardware feature, and generate the unclonable and non-fungible identification information based on the bound biometric data and hardware feature and the unique digital code.

In some embodiments, processing unit 820 is further configured to create rights information for the user according to a role of the user and associate the rights information with the unclonable and non-fungible identification information. In some embodiments, a user may have different rights based on different biometric data provided according to a preset rule. For example, the biometric data of an index finger fingerprint corresponds to a first right, and the biometric data of a thumbprint corresponds to a second right. The rights management rule can be preset accordingly.

In some embodiments, processing unit 820 is further configured to generate a digital identifier according to the unclonable and non-fungible identification information; and embed the digital identifier into the unclonable and non-fungible data.

In some embodiments, apparatus 800 further includes a storing unit 830 including memory configured to store the right information and the unclonable and non-fungible identification information. In some embodiments, storing unit 830 is a memory of the hardware device. In some embodiments, storing unit 830 is an external memory.

In some embodiments, apparatus 800 further includes an updating unit 840 including circuitry configured to provide an update to the hardware components of apparatus 800. For example, updating unit 840 is configured to provide a firmware upgrade to acquiring unit 810. Updating unit 840 may be referred to an updating circuitry.

In some embodiments, apparatus 800 can be a built-in or plug-in apparatus of a hardware device. That is, apparatus 800 can be integrated in a hardware device, or apparatus 800 can be communicatively coupled with a hardware device according to some standard protocol.

FIG. 8B is a schematic diagram illustrating the exemplary apparatus 800 for generating unclonable and non-fungible data, shown in FIG. 8A, further featuring a digital resources acquiring unit 813 within acquiring unit 810. Consistent with the disclosed embodiments, such a device may therefore generate unclonable and non-fungible data for data originating from an external device, e.g., external resource 100, consistent with the processes shown in FIGS. 1B, 1C, 2B, 2C, 2E, and 2F.

It will be appreciated that the unclonable and non-fungible data generated in accordance with any of the embodiments described herein (e.g., methods 400A, 400B, 500A, 500B, 600 and 700 shown in FIGS. 4A to 4B, and FIGS. 5 to 7 and or generated by apparatus 800 shown in FIG. 8) may be applied across a wide spectrum of industries and applications to manage and authenticate digital resources. Furthermore, embodiments of the present disclosure offer robust solutions that can be tailored to distinct needs or specific objectives. By way of example, for photographers, the present embodiments may be implemented to ensure the secure publication of their digital content and work, shielding content and origin in an unclonable system that deters unauthorized use and simplifies disputes. News organizations may leverage its verifiable digital fingerprint to combat misinformation, safeguarding the integrity of their articles and photos. Medical researchers may benefit from secure data sharing, facilitating collaboration and accelerating healthcare advancements. Financial and insurance sectors find streamlined documentation processes, enhanced by digital evidence and forensic verification automation. In the realms of blockchain, cryptocurrency, and NFTs, such unclonable and non-fungible data may underpin the production of cold wallets and the verification of digital assets like NFTs and real-world assets. Supply chain managers may utilize the unclonable and non-fungible data as a secure chain of custody to track goods and mitigate risks associated with counterfeit products. AI developers may use the unclonable and non-fungible data as an irrefutable proof of ownership and defending intellectual property rights. In addition, documentation and evidence play a valuable role in the AI Autonomous machine industry, encompassing self-operating robots, drones, and vehicles. These entities may utilize unclonable and non-fungible data to authenticate sensor-generated digital resources, ensuring their accuracy and integrity. This authentication enables precise documentation and evidence collection, especially in situations where these machines need to provide proof, such as in legal proceedings, accident investigations, or compliance with regulatory standards. E-commerce sellers may register products in the form of unclonable and non-fungible data, establishing immutable records of ownership and provenance to combat counterfeiting. In government services, unclonable and non-fungible data ay improve the efficiency of processes such as patent issuance and verification, reducing fraud, voting and benefits administration.

Embodiments of the present disclosure further provide methods for verifying and authenticating unclonable and non-fungible identification resource.

In some example embodiments, verification and authentication of unclonable and non-fungible data may be performed locally by a specific device or apparatus. For instance, consider an apparatus equipped with the capability to produce unclonable and non-fungible data. When this apparatus receives such data, it may need to verify whether the received data has been generated by itself. Referring to FIGS. 8A-8B, apparatus 800 via processing unit 820 may receive unclonable and non-fungible data. Upon reception, processing unit 820 may detect unclonable and non-fungible identification information embedded into unclonable and non-fungible data, and extract unclonable and non-fungible identification information from unclonable and non-fungible data 140, thereby further obtaining original data 120. Subsequently, processing unit 820, based on at least one of a hardware feature or biometric data collected by acquiring unit 810, may decrypt unclonable and non-fungible identification information to obtain unique digital code for the data. Processing unit may then generate a comparative unique digital code for the data based on the obtained original data. If the decrypted unique digital code for the data matches the generated comparative unique digital code for the data, the authenticity of the original data is established. In other words, unclonable and non-fungible data has been generated by apparatus 800 based on at least one of the hardware feature or the biometric data collected by acquiring unit 810.

Alternatively, in some other example embodiments, verification and authentication of unclonable and non-fungible identification data may be conducted remotely by a server or cloud-based service. The process of verification and authentication remains similar as the one described above, but there is a distinction: since the server or cloud system may lack prior knowledge of the hardware features or biometric data utilized for the unclonable and non-fungible identification information, a preliminary registration of such hardware features and biometric data may be necessary before initiating any verification and authentication process. For instance, a security chip, security module, or apparatus utilized for generating unclonable and non-fungible data would initially undergo a registration process, where it would specify at least one hardware feature or biometric data utilized for the generation of unclonable and non-fungible identification information. Once registered, any unclonable and non-fungible data produced by these devices could be verified and authenticated by the server or cloud system. The hardware features and biometric data would be securely stored in a dedicated database accessible only to the server or cloud system. In certain embodiments, bound hardware features and biometric data may be submitted as part of the registration process.

The unclonable and non-fungible data generated in accordance with the embodiments described herein differ from traditional authentication mechanisms in several aspects. Firstly, it employs up to three distinct identities-biometric data, hardware feature (e.g., PUF), and unique code (e.g., content hash)-not only for authenticating humans and hardware but also for verifying digital resources and their provenance and truth. Secondly, the process of generating codes, digital watermarks, signatures, identifiers, and hashes occurs entirely in a local environment, avoiding reliance on servers or centralized systems. Notably, the unclonable and non-fungible identification information is never stored anywhere. Thirdly, this system focuses on digital resource-centric authentication by embedding watermarks, digital signatures, and identifiers or associating such markers directly into the resources. Additionally, it enhances the interoperability and efficiency of digital resources, particularly in relation to blockchain technology. Still further, digital resources authenticated by the present embodiments described herein can be traced and verified both locally and centrally, providing comprehensive information on the who, where, what, and when of each resource.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that the relational terms herein such as “first” and “second” are used only to differentiate an entity or operation from another entity or operation, and do not require or imply any actual relationship or sequence between these entities or operations.

Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units. By way of example, in the disclosed embodiments for content generation and processing, the computing and functional units can be seamlessly integrated into System-on-Chip (SoC) architectures. The versatility of these units allows for their efficient incorporation into SoC designs, leveraging the benefits of integrated hardware and software solutions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequences of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

1. A method for generating unclonable and non-fungible data, comprising:
acquiring a hardware feature of a hardware device and a biometric data of a user;
generating a unique digital code for generated data;
generating unclonable and non-fungible identification information based on the unique digital code, the hardware feature and the biometric data; and
associating the unclonable and non-fungible identification information with the generated data to obtain unclonable and non-fungible data.

2. The method according to claim 1, wherein the data is generated by at least one of the user using the hardware device or the user using an external hardware device.

3. The method according to claim 1, wherein generating the unclonable and non-fungible identification information based on the biometric data, the hardware feature, and the unique digital code further comprises:
binding the biometric data and the hardware feature to generate a binding code; and
generating the unclonable and non-fungible identification information based on the unique digital code and the binding code.

4. The method according to claim 3, wherein the binding code is computed locally within the hardware device.

5. The method according to claim 3, wherein binding the biometric data and the hardware feature includes using at least one of a mathematical function or a hashing algorithm to generate the binding code.

6. The method according to claim 3, further comprising:
using the binding code to generate a pair of public and private keys;
using the private key to encrypt the unique digital code and generate the unclonable and non-fungible identification information; and
registering the public key on a central server.

7. The method according to claim 1, further comprising:
creating rights information for the user according to a role of the user;
associating the rights information with the unclonable and non-fungible identification information; and
storing the associated right information and the unclonable and non-fungible identification information.

8. The method according to claim 7, wherein the role comprises one or more of an owner of the hardware device, a creator of the data, or an owner of the data; and
the rights information comprises one or more of access rights to the hardware device; operation rights to the hardware device; or operation rights to the data.

9. The method according to claim 1, wherein the unique digital code is a hash value.

10. The method according to claim 1, wherein the unclonable and non-fungible identification information is a character string.

11. The method according to claim 1, further comprising:
generating a digital identifier according to the unclonable and non-fungible identification information; and
embedding the digital identifier into the unclonable and non-fungible data.

12. The method according to claim 11, wherein the digital identifier comprises one or more of: a digital watermarking, a digital signature, or a digital certificate.

13. The method according to claim 1, wherein the hardware device comprises one or more of a sensor, a microphone, or a camera.

14. The method according claim 1, wherein the hardware feature comprises a physically unclonable function (PUF) of the hardware device.

15. The method according to claim 1, wherein the generated data is any one of a text, a piece of code, a software, an image, an audio file, a video file, a data flow, or a piece of stream data.

16. The method according to claim 1, wherein associating the unclonable and non-fungible identification information with the generated data to obtain unclonable and non-fungible data includes at least one of embedding, referencing, mapping, linking, tagging, or cross-referencing the unclonable and non-fungible identification information within the generated data.

17. An apparatus for generating unclonable and non-fungible data, comprising:
an acquiring unit configured to acquire a hardware feature of a hardware device and biometric data of a user; and
a processing unit coupled to the acquiring unit and configured to:
generate a unique digital code for generated data;
generate unclonable and non-fungible identification information based on the unique digital code, the hardware feature and the biometric data; and
associate the unclonable and non-fungible identification information with the generated data to obtain unclonable and non-fungible data.

18. The apparatus according to claim 17, wherein the data is generated by at least one of the user using the hardware device or the user using an external hardware device.

19. The apparatus according to claim 17, wherein the acquiring unit is further configured to:
bind the biometric data and the hardware feature to generate a binding code; and
generate the unclonable and non-fungible identification information based on the unique digital code and the bound biometric data and hardware feature.

20. The apparatus according to claim 19, wherein binding the biometric data and the hardware feature includes using at least one of a mathematical function or a hashing algorithm to generate the binding code.

21. The apparatus according to claim 19, wherein the processing unit is further configured to:
use the binding code to generate a pair of public and private keys;
use the private key to encrypt the unique digital code and generate the unclonable and non-fungible identification information; and
register the public key on a central server.

22. The apparatus according to claim 17, wherein the processing unit is further configured to:
create rights information for the user according to a role of the user; and
associate the rights information with the unclonable and non-fungible identification information; and
the apparatus further comprises a storing unit configured to store the unclonable and non-fungible identification information.

23. The apparatus according to claim 22, wherein the processing unit is further configured to:
generate a digital identifier according to the unclonable and non-fungible identification information; and
embed the digital identifier into the unclonable and non-fungible data.

24. The apparatus according to claim 23, wherein the digital identifier comprises one or more of: a digital watermarking, a digital signature, or a digital certificate.

25. The apparatus according to claim 17, wherein the acquiring unit comprises one or more of a sensor, a microphone, or a camera.

26. The apparatus according to claim 17, wherein the hardware feature comprises a physically unclonable function (PUF) of the hardware device.

27. The apparatus according to claim 17, wherein the unique digital code is a hash value.

28. The apparatus according to claim 17, wherein the generated data is any one of a text, a piece of code, a software, an image, an audio file, a video file, a data flow, or a piece of stream data.

29. The apparatus according to claim 17, further comprising an updating unit configured to upgrade a firmware of the acquiring unit.

30. The apparatus according to claim 17, wherein associating the unclonable and non-fungible identification information with the generated data to obtain unclonable and non-fungible data includes at least one of embedding, referencing, mapping, linking, tagging, or cross-referencing the unclonable and non-fungible identification information within the generated data.

31. A non-transitory computer readable medium that stores a set of instructions executable by one or more processors of an apparatus to cause the apparatus to perform operations comprising:
acquiring a hardware feature of a hardware device and biometric data of a user;
generating a unique digital code for generated data;
generating unclonable and non-fungible identification information based on the unique digital code and of the hardware feature of the hardware device and the biometric data of the user; and
associating the unclonable and non-fungible identification information with the generated data to obtain unclonable and non-fungible data.

32. The non-transitory computer readable medium according to claim 31, wherein the data is generated by at least one of the user using the hardware device or the user using an external hardware device.

33. The non-transitory computer readable medium according to claim 31, wherein the operations further comprise:
binding the biometric data and the hardware feature; and
generating the unclonable and non-fungible identification information based on the unique digital code and the bound biometric data and hardware feature.

34. The non-transitory computer readable medium according to claim 33, wherein the binding code is computed locally within the apparatus.

35. The non-transitory computer readable medium according to claim 33, wherein binding the biometric data and the hardware feature includes using at least one of a mathematical function or a hashing algorithm to generate the binding code.

36. The non-transitory computer readable medium according to claim 33, wherein the operations further comprise:
using the binding code to generate a pair of public and private keys;
using the private key to encrypt the unique digital code and generate the unclonable and non-fungible identification information; and
registering the public key on a central server.

37. The non-transitory computer readable medium according to claim 31, wherein the operations further comprise:
creating rights information for the user according to a role of the user;
associating the rights information with the unclonable and non-fungible identification information; and
storing the unclonable and non-fungible identification information.

38. The non-transitory computer readable medium according to claim 31, wherein the operations further comprise:
generating a digital identifier according to the unclonable and non-fungible identification information; and
embedding the digital identifier into the unclonable and non-fungible data.

39. The non-transitory computer readable medium according to claim 31, wherein associating the unclonable and non-fungible identification information with the generated data to obtain unclonable and non-fungible data includes at least one of embedding, referencing, mapping, linking, tagging, or cross-referencing the unclonable and non-fungible identification information within the generated data.
